(19) United States
(12) Patent Application Publication
(10) Pub. No.: US 2013/0218302 A1
(43) Pub. Date: Aug. 22, 2013

(54) DISTRIBUTED CONTROL SYSTEM OPERATION AND CONFIGUATION

(71) Applicants: Richard A. Leinen, Wilsonville, OR (US); David E. Burgess, Beaverton, OR (US); Scott Alexander Anderson, Tualatin, OR (US)

(72) Inventors: Richard A. Leinen, Wilsonville, OR (US); David E. Burgess, Beaverton, OR (US); Scott Alexander Anderson, Tualatin, OR (US)

(73) Assignee: LEVITON MANUFACTURING CO., INC., Melville, NY (US)

(21) Appl. No.: 13/812,784

(22) PCT Filed: Jul. 30, 2010
(86) PCT No.: PCT/US10/44007

§ 371 Date: Apr. 11, 2013

(51) Int. Cl. G05B 15/02

(52) U.S. Cl. CPC G05B 15/02
USPC 700/17; 700/19

(57) ABSTRACT

A device including a controller; and a communication interface coupled to the controller and configured to be coupled to a control system including a plurality of control system components where each control system component configured to include an associated configuration. The controller is configured to identify a configuration of the control system through the communication interface, and the configuration of the control system includes the configurations associated with the control system components.

### BACKGROUND

This disclosure relates to control system operation and configuration, and in particular, to operation and configuration of a distributed control system.

Control systems, such as a lighting control system, typically have a central controller. Signals from switches, occupancy sensors, photocells, or the like are input into the central controller. The central controller processes the inputs and generates signals to control electrical loads, such as lighting circuits, HVAC system components, or the like. The central controller can be updated with a new configuration as the configuration of the control system is located at the central controller. However, if components contain individual configurations, no central location exists for a configuration of the control system.

### BRIEF DESCRIPTION OF THE DRAWINGS

FIG. 1 illustrates an embodiment of a device for configuring a control system according to some inventive principles of this patent disclosure.

FIG. 2 illustrates an embodiment of a control system according to some inventive principles of this patent disclosure.

FIG. 3 is a flowchart illustrating querying of a configuration of a control system according to some inventive principles of this patent disclosure.

FIG. 4 is a flowchart illustrating identification of a configuration of a control system according to some inventive principles of this patent disclosure.

FIG. 5 is a flowchart illustrating creating a configuration of a control system according to some inventive principles of this patent disclosure.

FIG. 6 illustrates an embodiment of a control system interface of the device of FIG. 1 according to some inventive principles of this patent disclosure.

### DETAILED DESCRIPTION

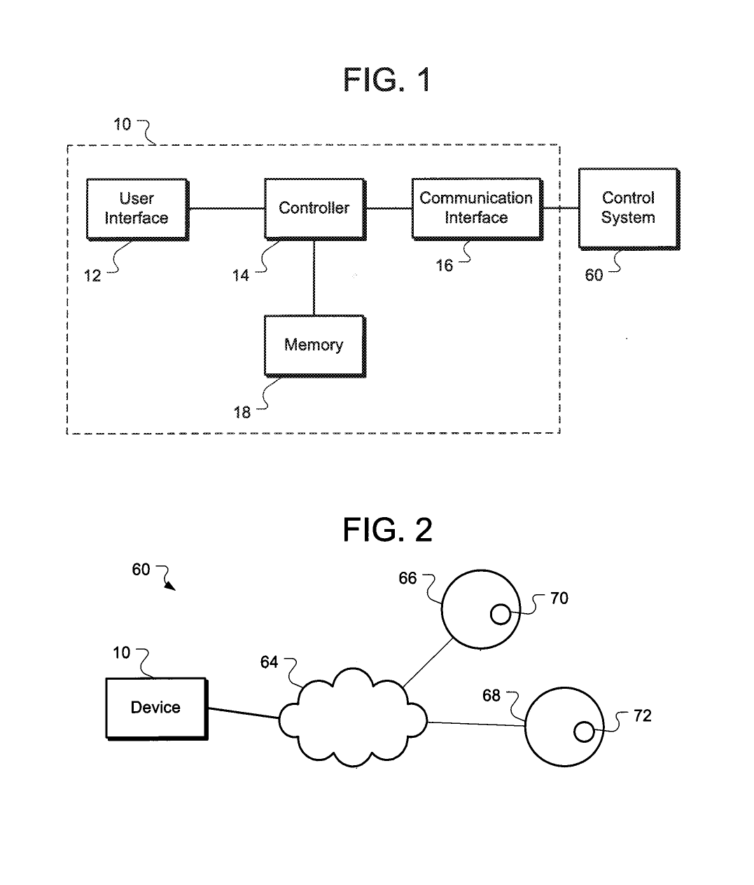

FIG. 1 illustrates an embodiment of a device for configuring a control system according to some inventive principles of this patent disclosure. In this embodiment, the device 10 includes a user interface 12, a controller 14, a communication interface 16, and a memory 18. The user interface 12, communication interface 16, and memory 18 are coupled to the controller 14.

The controller 14 can include any variety of circuitry. In embodiment, the controller 14 can include digital circuitry such as general purpose processors, digital signal processors, programmable logic devices, application specific integrated circuits, or the like. Any such circuitry and/or logic can be used to implement the controller 14 in analog and/or digital hardware, software, firmware, etc., or any combination thereof.

The memory 18 can include any variety of memory. For example, the memory can include dynamic memory, static memory, random access memory, flash memory, mass storage devices, removable storage devices, or the like. Any memory that can be written to more than once can be used. However, in an embodiment, other memory, such as read only memories, can also be included in the memory 18. As will be described in further detail below, the memory 18 can be configured to store a configuration for a control system 60. In addition, the memory 18 can be configured to store a configuration for the communication interface 16.

The communication interface 16 can include any variety of interfaces. For example, the communication interface 16 can include interfaces such as a serial interface, a parallel interface, a wired or wireless interface, a radio frequency interface, an optical interface, or the like. The communication interface 16 can include an Ethernet interface, a Bluetooth interface, a universal serial bus (USB) interface, a controller area network (CAN) interface, a combination of such interfaces, or any other interface. Accordingly, the device 10 can be configured to communicate with a control system.

In an embodiment, the device 10 can be configured to be coupled to a control system including multiple control system components through the communication interface 16. The controller 14 can be configured to identify a configuration of the control system 60 through the communication interface 16.

A configuration can include any variety of information related to components of a control system. For example, the configuration can include a definition of how components respond to inputs. The configuration can include code for various controllers of the components. The configuration can include a hierarchy and/or grouping of components. The configuration can include environmental information related to the control system. Any such information or combinations of information can be part of the configuration.

FIG. 2 illustrates an embodiment of a control system according to some inventive principles of this patent disclosure. In this embodiment, the control system 60 includes components 66 and 68 coupled to a communication link 64. However, the control system 60 can include any number of components and communication links and any interconnection of components and communication links.

The communication link 64 can include a variety of communication system that can provide for communication between multiple devices. For example, a communication link can include a wireless or wired network. The communication link can include networks such as a controller area network (CAN), an Ethernet network, any other multi-node network, a combination of such networks, or the like.

The components 66 and 68 can be any variety of control system components. For example, in the context of a lighting control system, a component can include an occupancy sensor, a switch, a photocell, a time clock, or the like. Other examples of components include relays, ballasts, circuit breakers, displays, user interfaces, combinations of such components, or the like. Other devices and/or systems that may or may not be part of a lighting control system can be a component. For example, a component can include a thermostat, an accelerometer, keyboard, touch screen, computer, processor, or the like. Any component from other types of control systems, such as security systems, home automation systems, building automation systems, or the like, can be components of the control system 60.

Each of the components 66 and 68 can be configured to store a respective configuration 70 and 72. An aggregate of these configurations 70 and 72 can be referred to as a configuration of the control system 60. That is, even though the configurations 70 and 72 are distributed throughout the control system 60 in components 66 and 68, the configurations 70 and 72 can define how the control system 60 operates, how control information is processed, or the like.

The device 10 can also be coupled to the communication link 64. The device 10 can be configured to be part of the control system 60, can be configured to be temporarily coupled to the control system 60, or the like. Through the device 10, the control system 60 can be configured. For example, the configurations 70 and 72 of the components 66 and 68 can be installed, updated, modified, or the like by the device 10.

Referring to FIGS. 1 and 2, the device 10 can include a user interface 12. The user interface can include any variety of interfaces. For example, the user interface 12 can include displays, buttons, keys, knobs, touch screens, peripheral interfaces, a combination of such interfaces, or the like. In an embodiment, through the user interface, the controller 14 can be configured to receive environmental information for the control system 60.

Environmental information can include astronomical information, such as time of day, month, year, sunrise, sunset, phase of the moon, tidal information, combinations of such information, or the like. The controller 14 can be configured to update a configuration of the control system 60 in response to the environmental information. For example, the controller 14 can update a locally stored configuration in the memory 18. At a later time, as described below, the configuration can be transmitted to one or more components of the control system 60. In another example, the controller 14 can be configured to update the configuration of the control system 60 as the environmental information is received.

The user interface 12 can also be configured to receive operational information for at least one of the components of the control system 60. Operational information can include information related to how the component responds to stimuli, different operating modes of the component, on what conditions the component will change operating modes, schedules of operating mode changes, or the like. For example, the operational information can include an operating mode for the component for daytime, an operating mode for the component for nighttime, and a schedule indicating when the transition from the daytime operating mode to the nighttime operating mode occurs.

Operational information can also include identifications of the component, associations of the component with other components, combinations of such information, or the like. For example, each component can have an individual identification. Components can also be associated with groups of components. The group of components can be configured to respond to substantially similar inputs. The operational information can include an identification of the group of components. Components can also be associated together in areas. That is, components may not respond to the same inputs; however the components may respond to the same schedule of operating mode changes.

For example, within a conference room, different relays for different lighting fixtures may be controlled by different switches. The relays for one set of fixtures may be controlled by a particular set of switches. Those relays can form a group. The conference room can have other groups of relays, switches, relays the like. However, since these components are all within the same conference room, the components can follow the same schedule of operating mode changes. That is, even though the components are responsive to different inputs, a change in operational modes of components in the same area can occur at the same time. For example, the change in operational modes for components in the conference room from a daytime operational mode to a nighttime operational mode can occur at substantially the same time. Accordingly, the groups of components can be associated with an area with such a daytime/nighttime operational mode change.

Although an area has been described as a conference room, an area can include larger or smaller physical spaces, different logical groupings of spaces, or the like. For example, each cubicle within an office space can form an area. In another example, each building of a facility can form an area. Any organization where a change in operating mode can occur in response to a common stimuli can form an area.

Similar to the usage of environmental information, the controller can be configured to update the configuration of the control system in response to the operational information. Moreover, the controller 14 can be configured to update a component of the control system 60, for example, with an updated group identification, area identification, schedule association, or the like. As will be described in further detail below, the updates to the configuration and/or the components can occur in a variety of ways.

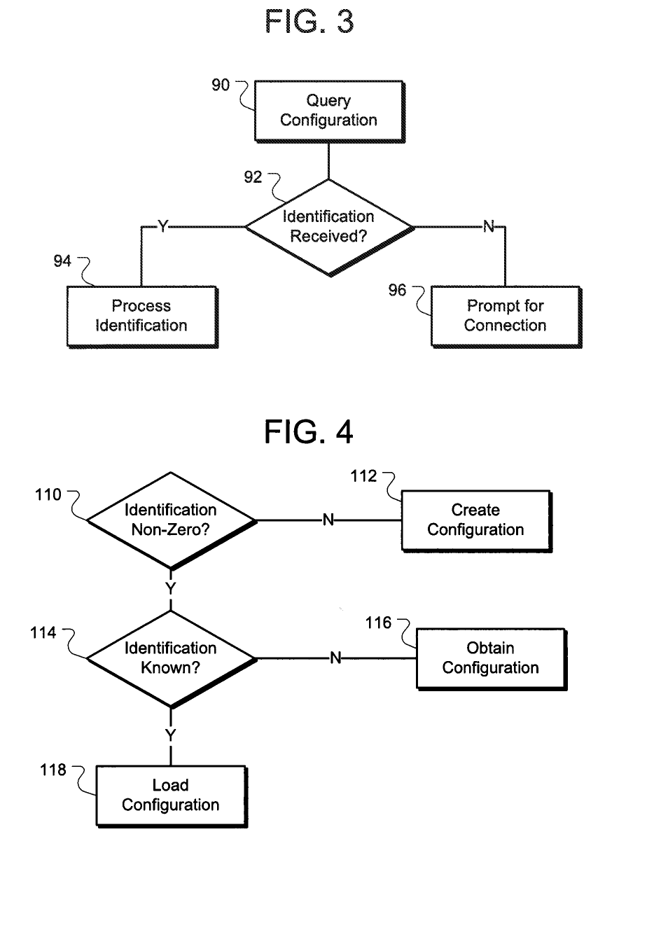

FIG. 3 is a flowchart illustrating querying of a configuration of a control system according to some inventive principles of this patent disclosure. For ease of discussion, FIGS. 3-5 will refer to the control system 60 and device 10 of FIGS. 1 and 2 as examples; however, these techniques can be applied to other control systems and devices.

In 90, the configuration can be queried. For example, the device 10 can transmit a broadcast message through a communication interface 16 over the communication link 64. A component 66 can be configured to respond to such a message. Although a broadcast message has been used as an example, other types of messages can be used. For example, a multi-cast message can be used, a message addressed to a predefined address can be used, or the like.

If an identification is received in 92, the identification can be processed in 94. However, if an identification is not received in 92, a user of the device 10 can be prompted to connect the device 10 to a control system. That is, if the device 10 is not connected to a control system, no component will be able to respond. Similarly, if the device 10 is coupled to a communication system unfamiliar with the protocols of the device 10 and the control system, 60, no response will be received. A user can prompted in a variety of ways. For example, the user can be notified through a user interface 12 of the device 10. A message on a display, an indicator light, an audible tone, or any notification can be provided through the user interface 12 to prompt the user.

FIG. 4 is a flowchart illustrating identification of a configuration of a control system according to some inventive principles of this patent disclosure. As described above, an identification can be obtained from the control system 60. In 110, a determination can be made if the identification is non-zero. If the identification is zero, a configuration is created in 112. An identification of zero is used as an example of an identification that the control system 60 has not been configured. A system that has not been configured can include a control system 60 that has been installed, but does not yet have an associated configuration. In another example, a system that has not been configured can include a control system 60 that has a default configuration, a minimal configuration, a non-site-specific configuration, partial configuration, or the like. Although zero has been given as an example, any identification could be used to specify that the control system 60 has not been configured if the control system 60 and the device 10 can understand the meaning of that identification.

If the identification is non-zero, a determination can be made in 114 if the identification matches an identification of a configuration stored in a memory of the device 10. For example, the device 10 can be configured to store multiple configurations for the same or different control systems. These configurations can have associated identifications. If the identification matches an identification of a stored configuration, that configuration can be loaded into the device in 118. Accordingly, the control system 60 and its components can be configured, controlled, or the like as the device has the configuration of the control system 60.

However, if the identification does not match an identification of a configuration in memory, the controller can be configured to obtain the configuration of the control system through the communication interface. For example, a component, such as component 66, can be configured to maintain a configuration for the entire control system 60. In another example, each component can be configured to maintain its own configuration. Regardless of how it is distributed, the device 10 can be configured to communicate with the components to obtain the configuration of the control system 60.

The configuration can then be stored in the device 10. Thus, if the device 10 is coupled to the control system 60 again, the device can have the configuration associated with the identification stored in memory. As a result, the device 10 need not obtain the configuration again from the control system 60.

The identification of a configuration of a control system 60 can be a substantially unique identifier. For example, the identification can be a globally unique identifier or GUID. However, in an embodiment, the identification may not include sufficient information to distinguish different configurations of the same control system 60. For example, the identification can be an identification of the control system 60 yet may lack identification of a particular versions, constituent components, component configurations, or the like. Accordingly, even if the identification is known and can be loaded into the device 10, the configuration of the control system 60 may still be different from the loaded configuration. Accordingly, the device 10 can be configured to query the control system 60 to determine if the configuration has been updated. If so, the device 10 can be configured to obtain the configuration, the updated portions, or the like.

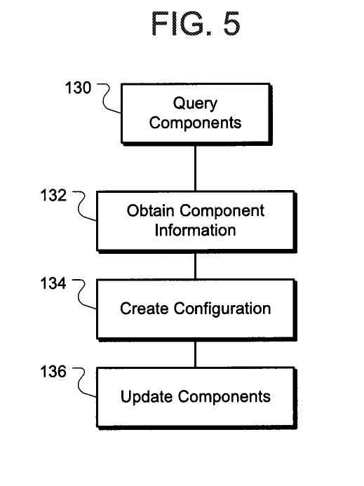

FIG. 5 is a flowchart illustrating creating a configuration of a control system according to some inventive principles of this patent disclosure. As described above, the control system 60 may not have been configured. Accordingly, a configuration is not available. The device can be configured to create a configuration for the control system 60.

For example, in 130, components of the control system 60 can be queried. A broadcast message can be transmitted on the communication link 64. Each of the components 66 and 68 of the control system 60 can be configured to respond with information. Thus, in 132 the device 10 can be configured to obtain the component information.

Although transmitting a broadcast message has been used as an example, other techniques of querying the control system 60 for components can be used. For example, addresses of the communication link 64 can be polled. In another example, a master component can be queried for a list of components. In another example, the querying can be a multi-stage process. For example, a component, such as component 66 may serve as a router for communications between components of the control system. The component 66 can be configured to obtain information about components coupled to the component 66. This information can be forwarded on to the device 10. Thus, regardless of location in the control system 60, techniques of communication, or the like, the device 10 can obtain component information on each component of the control system 60.

The component information can include any variety of information. For example, the component information can indentify the type of component, the capabilities of the component, location of the component, address of the component, or the like.

In response to the component information, the device 10 can be configured to create a configuration for the control system 60 in 134. In an embodiment, the configuration created in 134 can be a minimal configuration. For example, the created configuration may identify the components, their addresses or the like, but may not identify any associations of inputs to controlled components. Thus, with the minimal configuration, the control system may perform no operations. In another embodiment, a default configuration can be populated using the component information. The default configuration may have definitions for operations of the components that place the components in a fail-safe operating mode.

In yet another example, creating the configuration can include presenting a user of the device 10 with an interface to create the configuration. The user can associate input components to control components, create operating modes of the components, define system wide defaults, or the like as appropriate to the control system 60. Regardless, in 134 a configuration can be created. In addition an identification for the configuration can be created.

In 136, the control system 60 can be updated with the created configuration. For example, a component of the control system 60 can be updated with the newly created configuration. The component can be configured to distribute the configuration to the various components of the control system 60. In another example, the device 10 can be configured to update each component of the control system 60 with the corresponding portion of the configuration. In another embodiment, the division of responsibility in updating can be divided between any combination of the device 10 and other components of the control system 60. Regardless, the configurations of the components can be updated.

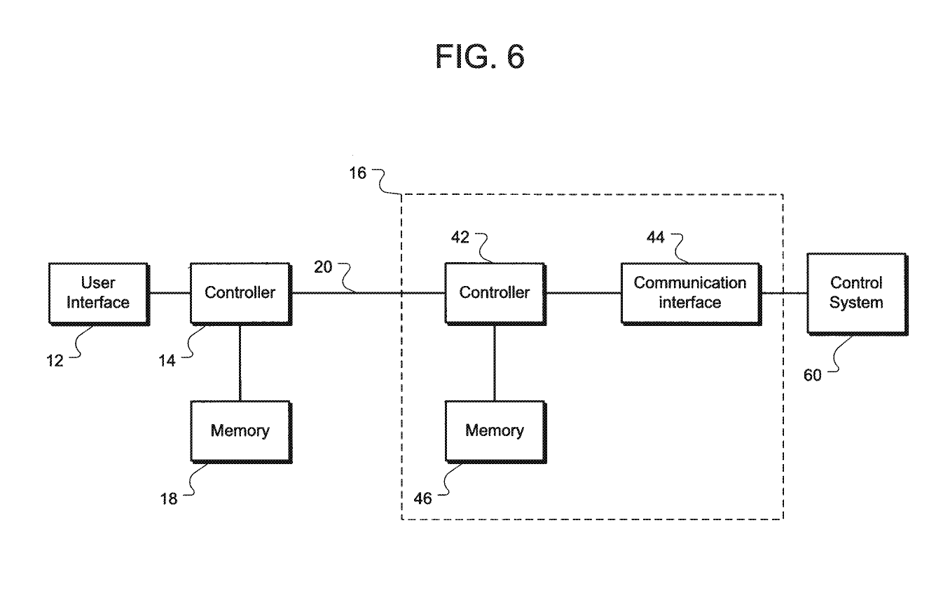

FIG. 6 illustrates an embodiment of a control system interface of the device of FIG. 1 according to some inventive principles of this patent disclosure. In this embodiment, the communication interface 16 of the device includes a first communication interface 20 between the controller 14 and a second controller 42. The second controller 42 is coupled to a second communication interface 44. The second communication interface 44 can be any variety of communication interface as described above. Similarly, the second controller 42 can be any variety of circuitry similar to the controller 14 described above.

The second controller 42 is coupled to a second memory 46. The second memory 46 can be configured to store a configuration for the communication interface 16. For example, the second memory 46 can be configured to store code for operation of the communication interface 16.

The first controller 14 can be configured to receive an update. Thus update can include code for the first controller 14 and the second controller 42. The controller 14 can be configured to update code in the first memory 18 in response to the code for the first controller 14. The controller 14 can be configured to transmit the code for the second controller 42 to the second controller 42 through the first communication interface 20. The second controller 42 can be configured to update the corresponding code in the memory 46. In an embodiment, the updated code for both the first controller 14 and the second controller 42 can be received by the first controller 14 in a single update.

In an embodiment, the control system interface 16 can be configured to translate communications from the first controller 14 to a format suitable for the control system 60. For example, the first controller 14 can be configured to communicate over a serial port as the first communication link 20. However, the control system 60 may communicate using a different communication link, such as a CAN. The second communication interface 44 can be a CAN interface. The second controller 42 can be configured to translate the communications over the serial communication link 20 to CAN communications suitable to transmit through the communication interface 44 to the control system 60.

Moreover, the inventive principles of this patent disclosure have been described above with reference to some specific example embodiments, but these embodiments can be modified in arrangement and detail without departing from the inventive concepts. Such changes and modifications are considered to fall within the scope of the following claims.

1. A device, comprising:
a controller; and
a communication interface coupled to the controller and configured to be coupled to a control system including a plurality of control system components, each control system component configured to include an associated configuration;
wherein:
the controller is configured to identify a configuration of the control system through the communication interface; and
the configuration of the control system includes the configurations associated with the control system components.

2. The device of claim 1, wherein the controller is configured to request an identification of the configuration of the control system through the communication interface.

3. The device of claim 2, further comprising:
a memory configured to store a plurality of configurations;
wherein the controller is configured to determine if the identification matches an identification of a configuration of the configurations stored in the memory.

4. The device of claim 2, further comprising:
a memory configured to store a plurality of configurations;
wherein the controller is configured to obtain the configuration of the control system through the communication interface if the identification of the control system does not match any identification of configurations stored in the memory.

5. The device of claim 2, wherein the controller is configured to create a configuration if the identification of the configuration of the control system indicates that the control system has not been configured.

6. The device of claim 5, wherein the controller is configured to identify the control system components of the control system.

7. The device of claim 5, wherein the controller is configured to obtain information associated with each of the control system components of the control system.

8. The device of claim 7, wherein the controller is configured to create the configuration in response to the information.

9. The device of claim 8, wherein the controller is configured to update at least one control system component with the configuration.

10. The device of claim 1, further comprising:
a user interface coupled to the controller and configured to receive environmental information;
wherein the controller is configured to update the configuration in response to the environmental information.

11. The device of claim 10, wherein environmental information includes at least one selected from the group consisting of time of day, day, month, year, sunrise, and sunset.

12. The device of claim 1, further comprising:
a user interface coupled to the controller and configured to receive operational information for at least one of the control system components;
wherein the controller is configured to update the configuration in response to the operational information.

13. The device of claim 1, further comprising:
a user interface coupled to the controller and configured to receive operational information;
wherein the controller is configured to update at least one control system component in response to the operational information.

14. A method of configuring a control system including a plurality of control system components, comprising:
coupling a device to a network coupled to the control system components, each control system component configured to include an associated configuration; and
identifying a configuration of the control system through a communication interface of the device;
wherein the configuration of the control system includes the configurations associated with the control system components.

15. The method of claim 14, further comprising requesting an identification of the configuration of the control system through the communication interface.

16. The method of claim 15, further comprising:
storing a plurality of configurations; and
determining if the identification matches an identification of a configuration of the configurations stored in the memory.

17. The method of claim 16, further comprising:
storing a plurality of configurations; and
obtaining the configuration of the control system through the communication interface if the identification of the control system does not match any identification of configurations stored in the memory.

18. The method of claim 15, creating a configuration if the identification of the configuration of the control system indicates that the control system has not been configured.

19. The method of claim 18, identifying the control system components of the control system.

20. The method of claim 18, obtaining information associated with each of the control system components of the control system.

21. The method of claim 20, creating the configuration in response to the information.

22. The method of claim 21, updating at least one control system component with the configuration.

23. The method of claim 14, further comprising:
receiving environmental information through a user interface; and
updating the configuration in response to the environmental information.

24. The method of claim 14, further comprising:
receiving operational information for at least one of the control system components through the user interface; and
updating the configuration in response to the operational information.

25. The method of claim 14, further comprising:
receiving operational information for at least one of the control system components through the user interface; and
updating at least one control system component in response to the operational information.

26. A device, comprising:
a first memory;
a first controller coupled to the memory;
a first communication interface coupled to the controller;
a second controller coupled to the first controller through the first communication interface;
a second memory coupled to the second controller; and
a second communication interface configured to be coupled to at least one control system component of a control system;
wherein the first controller is configured to receive an update including code for the first controller and the second controller, update code in the first memory in response to the code for the first controller, and transmit the code for the second controller to the second controller through the first communication interface.

27. The device of claim 26, wherein the first controller is configured to identify a configuration of the control system through the second communication interface.

28. The device of claim 26, wherein the first controller is configured to update a configuration of at least one control system component of the control system through the second communication interface.

29. A method, comprising:
receiving an update in a first controller;
updating code for the first controller in a memory coupled to the first controller in response to the update; and
transmitting code for a second controller in the update to the second controller through a first communication interface coupling the first controller and the second controller.

30. The method of claim 29, further comprising identifying a configuration of a control system through a second communication interface coupling the second controller to the control system.

31. The method of claim 29, further comprising updating a configuration of at least one control system component of a control system through a second communication interface coupling the second controller to the control system.
